(19) United States
(12) Patent Application Publication
(10) Pub. No.: US 2024/0166327 A1
(43) Pub. Date: May 23, 2024

(54) MULTIPLE GLAZED UNIT WITH MOUNTING GASKET INCORPORATING A REINFORCING AND SEALING ELEMENT

(71) Applicant: SAINT-GOBAIN GLASS FRANCE, COURBEVOIE (FR)

(72) Inventors: Jean-Charles SAUVESTY, SULLY SUR LOIRE (FR); Ludovic CHAUVETTE, COULLONS (FR)

(21) Appl. No.: 18/550,858

(22) PCT Filed: Feb. 11, 2022
(86) PCT No.: PCT/FR2022/050246

§ 371 Date: Sep. 15, 2023

(30) Foreign Application Priority Data
Mar. 16, 2021 (FR) FR2102610

(51) Int. Cl. B64C 1/14

(52) U.S. Cl. CPC B64C 1/1492; B64C 1/1484

(57) ABSTRACT

A multiple glazed unit includes a first pane and a second pane separated by an air gap, a mounting gasket covering a peripheral strip of the main surface of the first pane facing the second pane, the mounting gasket covering the edges of the first pane and of the second pane and occupying a peripheral portion of the air gap, a reinforcing and sealing element being incorporated in the mounting gasket by covering a peripheral portion of the main surface of the first pane facing the second pane and by engaging the edge of the second pane so as to limit the bending effect of the first pane.

The invention relates to multiple glazed units of the type subjected to pressurisation stresses and significant temperature differences on either side of the glazed units, such as passenger cabins of airplanes. A large number of airplanes are pressurized to balance the internal/external pressure, improve passenger comfort, particularly in the climbing and descent phase, and allow high-altitude flight. The deformation of an aircraft window is related both to this pressure and to the temperature gradient between an approximate indoor temperature of 20° C. and an outside temperature of about −40° C., for example.

An aircraft window is frequently composed of two panes, an external one intended to be in contact with the external atmosphere, and an internal one intended to be in contact with the interior volume of the aircraft or any other mounting environment. The two panes are frequently monolithic. They are substantially parallel, generally curved, spaced apart from each other, separated by an air gap, and embedded in a peripheral mounting gasket, for example overmolded.

A through-hole of small diameter can be formed in the internal pane in order to equalise the pressure of the air gap separating the internal and external panes with the cabin pressure. Under the effect of high-amplitude pressure and temperature variations, the external pane is subjected to significant mechanical bending and stresses. In the event of removal or breakage of the external pane, the internal pane is capable of ensuring the sealing of the system at airplane pressurisation. Depressurisation of the cabin then takes place very slowly, in a controlled manner, by the through-hole, with a whistling sound being emitted. In this case, there are setpoints for plugging this hole, for each window, for example by means of adhesive tape like Scotch® tape. The internal pane is called failsafe.

Alternatively, the external pane can consist of a laminated glazed unit, that is to say two transparent sheets made of polymer material or mineral glass, bonded to one another by an adhesive interlayer. This variant makes it possible to add features to the pane, relative to a monolithic external pane.

On laminated external-pane windows, there is a significant risk of humidity penetrating into the structure, in particular through the mounting gasket, that can lead to delamination of the external pane. In addition, the adhesive interlayer can be subjected to tensile stresses under the effect of the pressurisation of the aircraft, which may cause delamination and bubbling at the interlayer, which can lead to the loss of the external pane.

For a multiple glazed unit (double, etc.) with an external laminated pane that is monolithic, in particular of the type subjected to pressurisation stresses and variations in external temperatures, there is a need to limit the bending of the external pane, to provide mainly via the shape of the edge and mating elements for mounting the multiple glazed unit, a maximum retention of the external pane, and to reduce the amount of humidity entering the structure of the multiple glazed unit when mounting, in order to reduce the risk of breakage and/or loosening of the external pane.

This aim has been achieved by the invention which, consequently, is a multiple glazed unit comprising at least one first pane and a second pane separated by an air gap, a peripheral portion of the multiple glazed unit being embedded in a mounting gasket covering the main surface of the first pane opposite to the second pane, over a certain distance from the edge of the multiple glazed unit, according to a peripheral strip of the surface of the first pane, the mounting gasket covering the edges of the first pane and of the second pane and occupying a peripheral portion of the air gap, between the two main surfaces facing the first pane and the second pane, characterised in that a reinforcing and sealing element is incorporated into the mounting gasket by covering a peripheral portion of the main surface of the first pane opposite the second pane, and supported on the edge face of the second pane, so as to limit the bending effect of the first pane.

To benefit from the effects of the invention, the first pane is particularly intended to be mounted as an external pane within the meaning of the introduction of this application, and the second pane as an internal pane.

The reinforcing and sealing element is made of a sufficiently rigid material capable of forming a moisture barrier. This rigid element opposes the bending deformation of the first pane by relying both on a peripheral portion of the external surface thereof and on the edge face of the second pane.

The mounting gasket is made of silicone or equivalent.

By virtue of the invention, the risks of humidity degradation, breakage and loosening of the first pane are thus reduced.

Preferably, the reinforcing and sealing element is made of metal such as stainless steel or aluminum, or composite such as thermosetting resin of an epoxy or unsaturated polyester type containing reinforcing fibers (glass fibers, carbon fibers), or aramid fibers such as is sold by the company DuPont de Nemours under the registered trademark Kevlar® or by the company Teijin under the registered trademark Twaron®.

Preferably, the first pane is a laminated glazed unit comprising a first acrylic or mineral glass sheet bonded to a second acrylic or mineral glass sheet by means of an adhesive interlayer made of thermoplastic polyurethane (TPU), polyvinyl butyral (PVB) or ethylene-vinyl acetate copolymer (EVA). An acrylic sheet is in particular composed of poly(methyl methacrylate) (PMMA). The term “mineral glass” should be understood to mean glass, in particular soda-lime, aluminosilicate, borosilicate, or float, optionally hardened, thermally tempered or chemically strengthened.

Preferably, the peripheral portion of the first pane covered by the mounting gasket is thinned relative to the central portion of the first pane, in order to allow the mounting structure to cover the mounting gasket while being flush with the main surface of the first (external) pane opposite the second pane. This flush placement is favorable from both an aerodynamic and an aesthetic perspective. The mounting structure referred to herein may consist of a window press for example bolted to the mounting structure (cabin, body, frame, etc.), which covers the mounting gasket by pinching and exerting pressure on the multiple glazed unit, so as to secure it.

Preferably, the second pane is monolithic, acrylic. It is intended to be in contact with the internal volume of the mounting structure (aircraft cabin, etc.). As indicated above, it is said to be failsafe, because it is designed to ensure the sealing of the enclosure under the pressurisation conditions and differences in outside and inside temperatures, in place of the first pane, in the event of breakage or loosening thereof.

According to a preferred variant, the part of the edge face of the first pane connecting the thinned peripheral portion of the first pane to the main surface of the first pane opposite the second pane has a shape on which a matching-shaped fold of the reinforcing and sealing element is fitted, in alignment, so as to ensure that the first pane is retained in place. This particular retention of the part of the thickness of the first pane furthest from the second pane, that is to say closest to the external surface of the multiple glazed unit, is advantageously combined with the opposition to the bending deformation of the first pane exerted by the support of the reinforcing element both on a peripheral portion of the external surface of the first pane and on the edge face of the second pane, in accordance with the invention. This particular retention also opposes the deformation by bending of the first pane and the loosening thereof.

Preferably, said shape and said fold then extend over the entire periphery of the multiple glazed unit in a continuous manner, or have a width of between 2 and 50 mm and are 3 to 50 in number over the entire periphery of the multiple glazed unit.

In a first embodiment of said preferred variant, said shape consists of a chamfer of the edge face of the first pane, retained by a fold of the reinforcing and sealing element.

In a second embodiment of this preferred variant, said shape consists of a square-profiled protuberance from a part of the edge surface of the first pane, held by a hook-shaped fold of the reinforcing and sealing element.

The object of the invention is also the application of a multiple glazed unit described herein above, in the wall of a volume subjected to pressurisation stresses, in particular as a side or front glazed unit of an aircraft, in particular as an airplane window. Commercial airliners, business jets, and any other craft subjected to cabin pressurisation are encompassed.

The invention is now described in reference to the annexed figures, in which

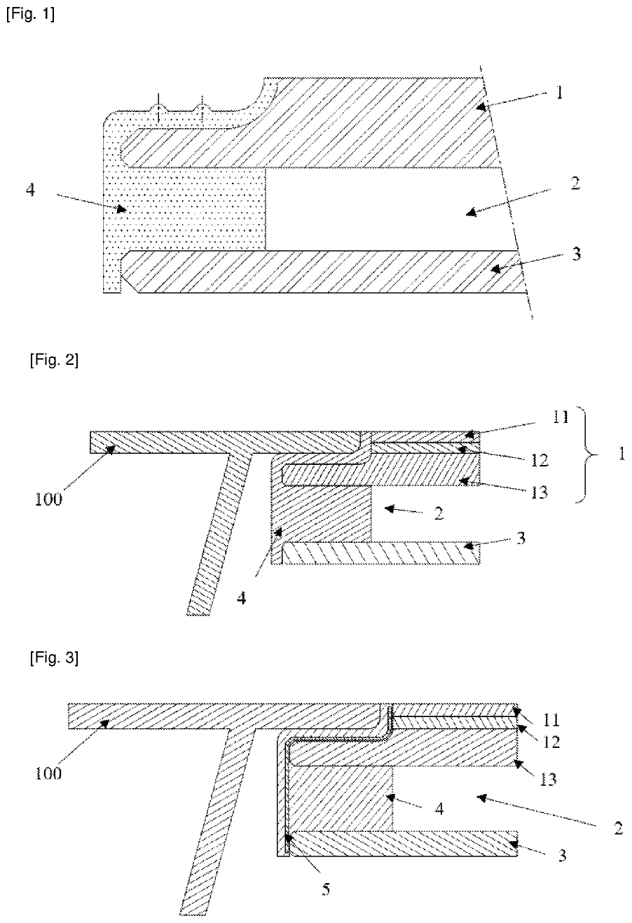

FIG. 1 is a cross-sectional view of a first aircraft window of the prior art;

FIG. 2 is a cross-sectional view of a second aircraft window of the prior art and its mounting environment;

FIG. 3 is a cross-section of a multiple glazed unit of the invention and of its mounting environment;

FIG. 4 is a cross-section of a first embodiment of a preferred variant of the multiple glazed unit of the invention and of its mounting environment; and

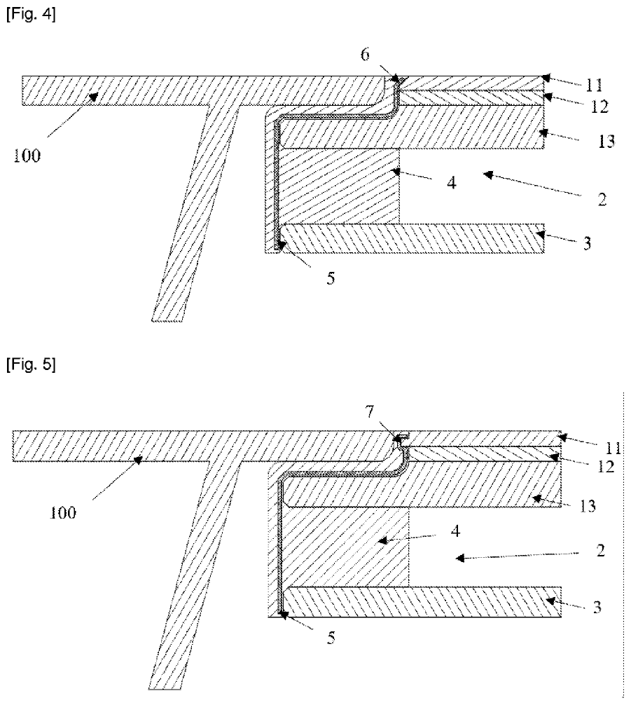

FIG. 5 is a cross-section of a second embodiment of a preferred variant of the multiple glazed unit of the invention and of its mounting environment.

With reference to FIG. 1, a commercial airplane passenger cabin window is composed of a first external pane 1 made of poly(methyl methacrylate) (PMMA) and of a second internal pane 3 made of PMMA. The two panes 1 and 3 are parallel, embedded in a silicone mounting gasket 4, which keeps them at a distance from one another so as to constitute an air gap 2.

A peripheral portion of the first pane 1 has a thinning. The mounting gasket 4 covers this thinned peripheral portion of the first pane 1, so that the part of the mounting gasket 4 distal to the second pane 3 forms a bowl (offset) with the central part of the main surface of the first pane 1 opposite the second pane 3.

The window of FIG. 2 has a mounting gasket 4 with such a bowl in the external surface area of the multiple glazed unit, this bowl receiving a window press 100 whose external surface is flush with that of the central part of the first pane 1. The window press 100 is bolted to the cockpit of the airplane, thus producing the (double) multiple glazed unit by exerting a certain pressure thereon.

Moreover, the first pane 1 here consists of a laminated glazed unit of a first chemically reinforced aluminosilicate glass sheet 11, bonded to a second sheet of PMMA 13 by means of a layer 12 of thermoplastic polyurethane (TPU).

With reference to FIG. 3, a reinforcing and sealing element 5 is incorporated into the mounting gasket 4 by covering a peripheral portion of the main surface of the first pane 11, 12, 13 opposite the second pane 3, and supported on the edge surface of the second pane 3 so as to limit the bending effect of the first pane 1. The reinforcing and sealing element 5 is made of stainless steel.

In FIG. 4, the first glass sheet 11 of the first pane is chamfered, allowing for a fold 6 of the reinforcing and sealing element 5 having a corresponding shape to contribute to the retention of the first pane, by reducing the risk of it coming loose.

In FIG. 5, the same effect as in FIG. 4 is achieved by a square-profiled protuberance of the edge face of the first glass sheet 11 onto which a matching hook-shaped fold 7 of the reinforcing and sealing element 5 is perfectly fitted.

The latter 5 prevents moisture from penetrating via the edge face of the laminated structure 11, 12, 13 of the first pane 1, and decreases or eliminates any risk of bubbling at the interlayer adhesive layer 12 of TPU, and of the delamination and breakage of the laminate.

1. A multiple glazing unit comprising at least one first pane and a second pane separated by an air gap, a peripheral portion of the multiple glazing unit being embedded in a mounting gasket covering a main surface of the first pane opposite to the second pane, over a certain distance from an edge of the multiple glazing unit, according to a peripheral strip of the main surface of the first pane, the mounting gasket covering edges of the first pane and of the second pane and occupying a peripheral portion of the air gap, between two main surfaces facing the first pane and the second pane, wherein a reinforcing and sealing element is incorporated into the mounting gasket by covering a peripheral portion of the main surface of the first pane opposite the second pane, and supported on an edge face of the second pane, so as to limit a bending effect of the first pane.

2. The multiple glazing unit according to claim 1, wherein the reinforcing and sealing element is metallic or composite.

3. The multiple glazing unit according to claim 1, wherein the first pane is a laminated glazing unit comprising a first sheet that is acrylic or made of mineral glass, bonded to a second sheet that is acrylic or made of mineral glass by an adhesive interlayer made of thermoplastic polyurethane (TPU), polyvinyl butyral (PVB) or ethylene-vinyl acetate copolymer (EVA).

4. The multiple glazing unit according to claim 1, wherein a peripheral portion of the first pane covered by the mounting gasket is thinner relative to a central part of the first pane, to allow a mounting structure to cover the mounting gasket while being flush with the main surface of the first pane opposite the second pane.

5. The multiple glazing unit according to claim 1, wherein the second pane is monolithic acrylic.

6. The multiple glazing unit according to claim 4, wherein a part of an edge face of the first pane connecting the thinned peripheral portion of the first pane to the main surface of the first pane opposite the second pane has a shape on which a matching-shaped fold of the reinforcing and sealing element is fitted, in alignment, so as to ensure that the first pane is retained in place.

7. The multiple glazing unit according to claim 6, wherein said shape and said matching-shaped fold extend over the entire periphery of the multiple glazing unit in a continuous manner.

8. The multiple glazing unit according to claim 6, wherein said shape and said matching-shaped fold have a width comprised between 2 and 50 mm and are 3 to 50 in number over the entire periphery of the multiple glazing unit.

9. The multiple glazing unit according to claim 6, wherein said shape consists of a chamfer of the edge face of the first pane, held by a fold of the reinforcing and sealing element.

10. The multiple glazing unit according to claim 6, wherein said shape consists of a square-profiled protuberance from a part of the edge surface of the first pane, held by a hook-shaped fold of the reinforcing and sealing element.

11. A wall of a volume subjected to pressurization stresses, said wall comprising a multiple glazing unit according to claim 1.

12. The wall according to claim 11, wherein the multiple glazing unit is a side or front glazing unit of an aircraft.

13. The wall according to claim 12, wherein the multiple glazing unit is an airplane window.
